(19) United States
(12) Patent Application Publication
(10) Pub. No.: US 2025/0094810 A1
(43) Pub. Date: Mar. 20, 2025

(54) ADAPTABLE AND CONTINUALLY LEARNING NEURAL NETWORK ARCHITECTURE

(71) Applicant: SRI International, Menlo Park, CA (US)

(72) Inventors: Zachary A. DANIELS, Robbinsville, NJ (US); Jun HU, Princeton, NJ (US); Michael R. LOMNITZ, Castro Valley, CA (US); Philip MILLER, Yardley, PA (US); Aswin NADAMUNI RAGHAVAN, Pennington, NJ (US); Yuzheng ZHANG, Princeton, NJ (US); Michael PIACENTINO, Southern Shores, NC (US); David C. ZHANG, Belle Mead, NJ (US); Michael ISNARDI, Plainsboro, NJ (US); Saurabh FARKYA, Jersey City, NJ (US)

(21) Appl. No.: 18/823,282

(22) Filed: Sep. 3, 2024

Related U.S. Application Data
(60) Provisional application No. 63/539,034, filed on Sep. 18, 2023.

(51) Int. Cl. G06N 3/084

(52) U.S. Cl. CPC G06N 3/084

(57) ABSTRACT

Method and apparatus for processing input information using an adaptable and continually learning neural network architecture comprising an encoder, at least one adaptor and at least one reconfigurator. The encoder, at least one reconfigurator and at least one adaptor determine whether the input information is out-of-distribution or in-distribution. If the input information is in distribution, the architecture extracts features from the input information, creates hyperdimensional vectors representing the features and classifies the hyperdimensional vectors. If the input information is out of distribution, the architecture creates at least one adaptor to operate with the encoder and the at least one reconfigurator to extract features from the input information, create hyperdimensional vectors representing the features and classify the hyperdimensional vectors.

### RELATED APPLICATION

This application claims benefit to U.S. Provisional Patent Application Ser. No. 63/539,034, filed 18 Sep. 2023 and entitled “Domain Adaptation And Continual Learning At The Edge,” which is hereby incorporated herein in its entirety by reference.

### GOVERNMENT RIGHTS

This invention was made with Government support under agreement no. 2022-21100600001, awarded by the Office of the Director of National Intelligence. The Government has certain rights in the invention.

### FIELD

Embodiments of the present principles generally relate to neural networks and, more particularly, to am adaptable and continually learning neural network architecture.

### BACKGROUND

Neural network (NN) architectures are important for solving tasks with human-like precision; however, traditional deep NN (DNN) architectures are extremely power intensive and unsuitable for incorporation into low-power devices (e.g., battery operated devices) such as devices that operate at the edge of a network (i.e., edge devices). Currently, DNNs can perform recognition and classification tasks with very high accuracy, but require long training times, consume a substantial amount of power, have a large memory footprint and are not adaptable to new domains.

Most machine learning (ML) systems assume stationary and matching data distributions during training and deployment. This is often a false assumption. When ML systems are deployed on real devices, data distributions often shift over time due to changes in environmental factors, sensor characteristics, and task-of-interest. While it is possible to utilize a human in the loop to monitor distribution shifts and engineer new architectures in response to the shifts, such an arrangement is not cost-effective—especially for edge devices.

Thus, there is a need for a neural network architecture that is adaptable and continually learning as well as memory and energy efficient.

### SUMMARY

Embodiments of the present invention generally relate to an adaptable and continually learning neural network architecture as shown in and/or described in connection with at least one of the figures.

More specifically, embodiments of the invention include a method, apparatus and computer readable media configured to process input data using machine learning comprising an encoder configured to encode input data to detect features in the input data. At least one reconfigurator, coupled to the encoder and comprising at least one out-of-distribution detector configured to detect when the input data is out-of-distribution. The at least one reconfigurator is configured to create at least one adaptor when the input data is out-of-distribution. The at least one adaptor, coupled to the encoder and the at least one reconfigurator, is configured to operate with the encoder and at least one reconfigurator to encode the out-of-distribution input data into an HD vector and classify the HD vector.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a block diagram of an exemplary computing device utilizing an adaptable and continually learning neural network architecture of at least one embodiment of the invention;

FIG. 2 depicts a block diagram of the EAR architecture in accordance with at least one embodiment of the invention;

FIG. 3 depicts a graph of an example distribution used to determine OOD data in accordance with at least one embodiment of the present invention;

FIG. 4 depicts a target projection Stochastic Gradient Descent (tpSGD) procedure for training a neural network for in accordance with at least one embodiment of the invention;

FIGS. 5A and 5B illustrate two procedures for constructing target features T for convolutional layers in accordance with at least one embodiment of the invention;

FIG. 6 depicts a graph of performance of the two procedures for constructing target features T for convolutional layers in accordance with at least one embodiment of the invention;

FIG. 7 depicts a representation of a simple recurrent cell and its “unrolled” equivalent that is used to formulate tpSGD update rules for recurrent neural networks in accordance with at least one embodiment of the invention;

FIG. 8 illustrates a definition of a transformer encoder layer in accordance with at least one embodiment of the invention;

FIG. 9 depicts a flow diagram of a method of operation of the adaptable and

continually learning neural network architecture in accordance with at least one embodiment of the invention; and

FIG. 10 depicts a computer system that can be utilized in various embodiments of the present invention to implement the computing device according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for creating and operating a computing device having an adaptable and continually learning neural network architecture. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments of a computing device comprising an adaptable and continually learning neural network architecture described herein enable many capabilities and applications not previously achievable thru any individual computing system. Embodiments of the disclosed architecture address the problem of decreasing size, weight, and power (SWaP) for computing devices as well as enable computing devices to locally perform artificial intelligence (AI) processing. Embodiments of the invention are especially useful in edge devices, i.e., computing devices that operate at the edge of communications networks such as mobile phones, laptop computers, Internet of Things (IoT) devices, and the like. Using embodiments of the invention enables edge devices to no longer rely upon centralized AI processing. In addition, embodiments of the invention facilitate continual learning to adapt the architecture to changing domains.

An example system application for embodiments of energy and memory efficient, field reconfigurable neural networks is the operation and communication of distributed smart sensors within a smart city. Cities are adding autonomous monitoring capabilities to support safety, health and the smooth flow of traffic and crowds. Cities have begun to add AI-based edge-based sensing and processing throughout to monitor vehicle traffic flow, air pollution, water levels, crowd monitoring, etc. Today edge-based sensing solutions require the cloud to retrain and reconfigure edge computing solutions within city network requiring the need for high data bandwidth, long communication times, long training times, large processor devices and high-power consumption.

To support the goals of smart cities to autonomously monitor operations including sensing from mobile platforms such as UAV aerial monitoring, cars, rechargeable portable bikes or scooters, etc., platform sensing and processing must be small and low power. For the timely autonomous monitoring of dynamically changing activities, events, objects, viewed by multiple sensors in a city it is required to retrain and adapt the neural network at the edge.

More specifically, embodiments of the adaptable, continually learning hyperdimensional neural network architecture comprise an encoder, at least one adaptor and at least one reconfigurator (referred to herein as an EAR architecture). The encoder is a fixed, pre-trained neural network designed to identify and classify initial in-distribution input data. The at least one adaptor is a shallow neural network that facilitates feature transfer to new data distributions (i.e., out-of-distribution (OOD) input data). The at least one reconfigurator is a light-weight neural network that enables rapid adaptation to new task spaces with little training. This EAR architecture 1) identifies when data distributions shift, 2) grows the machine learning model as needed, balancing performance on the new domain and model efficiency, and 3) performs continual learning via intelligent dynamic data routing through adaptors/reconfigurators to minimize catastrophic forgetting of previous domains.

In the following description, an applicable domain refers to the range or domain of data for which the model performs adequately for its intended purpose. This term broadly implies the characteristics and conditions of the data under which the model will function properly. Out of domain refers to data outside the original domain or range for which the model was designed or trained. This could include different characteristics or different types of data, not just different distributions. In distribution refers to data from the same distribution as the data set used when the model was trained. In other words, data with the types and characteristics of data that the model is familiar with. Out of distribution refers to data from a distribution that is different from the distribution of the data the model saw during training. This means data that is unknown or anomalous to the model. Out of distribution could refer to data that is generated after a change in sensors as well, a change in environment or a change in task.

Embodiments of the EAR architecture can be thought of as a special case of a progressive neural network. Progressive neural networks grow lateral connections, thus, avoiding forgetting at the cost of increased resource use. The EAR framework progressively grows additional adaptors and reconfigurators from a frozen feature encoder backbone. To extend progressive neural networks, the EAR architecture dynamically routes data through the appropriate adaptors/reconfigurators and, in one embodiment, utilizes zero shot neural architecture search (ZS-NAS) to identify where the adaptors should be added to the encoder and the structure (architecture) of the adaptors. In other embodiments, other techniques, such as other forms of neural architecture search (NAS) including, but not limited to, few-shot or full NAS, may be used to define the structure and connections for the adaptors. In some embodiments, the reconfigurators and/or adaptors may be trained using target projection stochastic gradient descent (tpSGD) which provides an efficient layer-by-layer learning technique.

The aforementioned embodiments produce a variety of technical effects. In some embodiments, the encoder neural network may be an existing, trained neural network that may be updated or enhanced through the addition of at least one reconfigurator and at least one adaptor. In this manner, an existing neural network may learn to classify new and previously unseen data. In some embodiments, the structure of the additional at least one reconfigurator and/or at least one adaptor may be defined by a NAS such as, for example, a ZS-NAS. The additional at least one reconfigurator and/or adaptor may be trained using a back-propagation free techniques such as, for example, tpSGD. Consequently, the neural network is adapted and rapidly trained to identify and classify previously unseen data. Such functionality is particularly useful in edge devices with limited computing resources.

The aforementioned embodiments and features are now described below in detail with respect to the Figures.

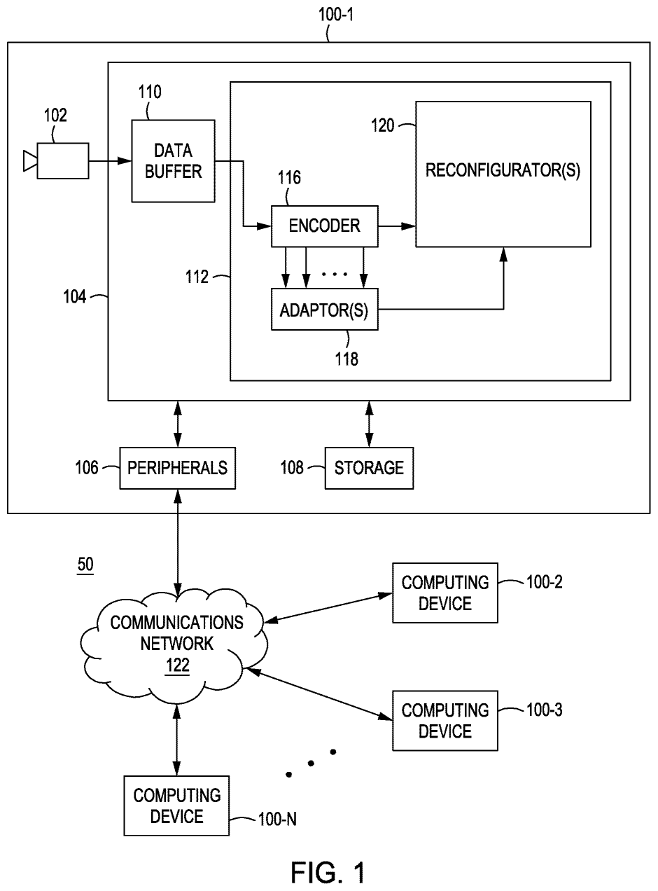

FIG. 1 depicts a block diagram of a network 50 comprising a plurality of computing devices 100-1, 100-2, 100-3, . . . 100-N, where N is an integer, coupled to one another through a communications network 122 in accordance with at least one embodiment of the invention. FIG. 1 depicts details of an exemplary computing device 100-1 utilizing an adaptable, continually learning hyperdimensional neural network EAR architecture 112 of at least one embodiment of the invention. In one embodiment, the computing devices 100-N may be an edge device, e.g., a computing device designed to operate on the edge of a communications network (i.e., Internet). The computing device 100-1 comprises a sensor 102 for collecting information regarding an environment surrounding the computing device 100-1. In at least one embodiment, the sensor 102 produces temporal data (i.e., time-variant data) such as video, audio, temperature, radiation, seismic, motion, radio frequency (RF) signals, text, biometric sensor data, etc. In a further embodiment, input information may be spatial data. In one embodiment, the sensor 102 is a video camera that generates a sequence of images (video frames). In other embodiments, the sensor 102 may be one or more of, but not limited to, microphone(s), radiation sensor(s), motion sensor(s), thermometers, chemical sensors, biomedical sensors, imaging sensors and the like.

The computing device 100-1 may be any form of computing device capable of processing data using an adaptable, hyperdimensional neural network EAR architecture 112 as described herein. Examples of such computing devices or platforms containing a computing device include, but are not limited to, mobile phones, tablets, laptop computers, personal computers, digital assistants, unmanned aerial vehicles, tactical communication devices, autonomous vehicles, autonomous robots, environmental monitoring devices, internet-of-things (IoT) devices, and the like.

The computing device 100-1 comprises at least one processing unit 104, peripherals 106 and digital storage 108 (i.e., non-transitory computer readable media). The digital storage 108 may be any form of memory device or devices such as, but not limited to, a disk drive, solid state memory, etc. The peripherals 106 may comprise one or more of, but not limit to, removable memory, displays, inertial measurement unit, GNSS (Global Navigation Satellite System) receiver, interfaces to networks 122 such as the Internet or other form of cloud computing network, debugging interfaces, and the like. Data as well as its classification may be exported from the device 100 to a network 122 for additional processing or analysis. The network 122 may also provide a connective path to other computing devices 100-2, 100-3, . . . 100-N.

The processing unit 104 comprises an implementation of the adaptable, continually learning hyperdimensional neural network EAR architecture 112. The processing unit 104, as described in detail below, may be implemented as software code (an application) executing on a computer, as an FPGA or as an ASIC. The processing unit 104 comprises a data buffer 110 and the EAR architecture 112 (encoder 116, at least one adaptor 118 and at least one reconfigurator 120). The structure and operation of the architecture 112 are described in detail below.

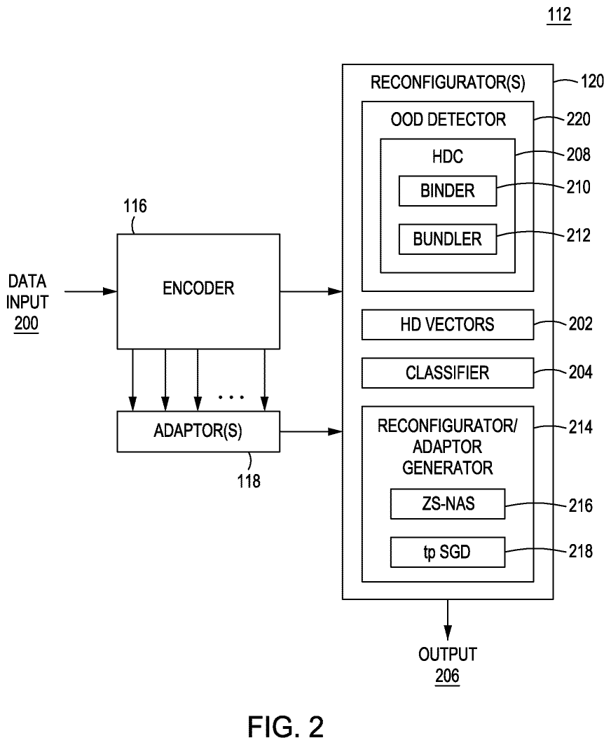

FIG. 2 depicts a functional block diagram of the adaptable, continual learning hyperdimensional neural network architecture 112 (the EAR architecture) in accordance with at least one embodiment of the invention. The EAR architecture 112 comprises an encoder 116, at least one adaptor 118, and at least one reconfigurator 120. In one embodiment, the input data 200 comprises temporal data (e.g., video, audio, temperature, radiation, seismic, motion, radio frequency (RF) signals, text, biometric sensor data, etc.) such that a sensor signal (e.g., an image frame of pixel data) is processed by a combination of the encoder 116, the at least one reconfigurator 120 and the at least one adaptor 118 to extract features and represent them as hyperdimensional (HD) vectors 202, where the HD vectors 202 represent, for example, image features within the image frame, i.e., a person, a vehicle, a sign, etc. The HD vectors 202 are applied to a classifier 204 defined by the at least one reconfigurator 120 where, in one embodiment, the classifier 204 identifies particular classes for the extracted features represented by the HD vectors 202, e.g., if the HD vector 202 represents a person, the classifier 204 may classify the person as performing a specific activity such as playing tennis (e.g., apply a label). Additionally, the HD vectors 202 are processed by the at least one reconfigurator 120 to determine if the data as represented by an HD vector is OOD. If the data is OOD, the at least one reconfigurator 120 creates an additional reconfigurator and adaptor to operate with the encoder 116 to classify the OOD data. The at least one reconfigurator 120 outputs, at output 206, the identified classes for the input data.

More specifically, the encoder 116 is a fixed, pre-trained neural network that extracts features from the input data and, operating with the at least one adaptor 118 and the at least one reconfigurator 120, classifies the features of the input data. Since the encoder 116 is a fixed neural network, it only recognizes features for input data that is in-distribution (ID) (i.e., within the scope of the training data). To recognize classes for data that is OOD from the initial training, the encoder 116 must be adapted to recognize features of such OOD data. This adaptation is performed by the at least one reconfigurator 120 generating additional reconfigurators and adaptors that are able to process the OOD input data.

The at least one reconfigurator 120 comprises an OOD detector 220 and a reconfigurator/adaptor generator 214. The OOD detector 220 comprises a neural network that automatically identifies when the input data distribution has changed (OOD detection). The OOD detector 220 only sees in-distribution (ID) samples during training. The OOD model uses adaptors 118 that project data into learned representations that can be used for joint OOD detection and classification. In some embodiments, the OOD detector 220 combines multi-layer feature analysis with learned representations, extending the HD feature fusion method by using adaptors 118 to automatically learn projections from features to HD vectors instead of using random fixed projection matrices.

The OOD detection and classification technique is built around hyperdimensional computing (HDC) 208. HDC 208 is a neuro-inspired neurosymbolic compute paradigm that represents discrete pieces of information as high-dimensional, low-precision, distributed vectors. In contrast to DNNs, HDC uses low-power, requires low-precision, and has been shown to be robust to corruptions in the input data. HDC 208 is built upon the mathematics of manipulating random pseudo-orthogonal vectors in high-dimensional spaces. HDC 208 is built around two key operations: 1) binding which takes two input vectors and generates a new vector that is dissimilar to each of the inputs (performed by binder 210) and 2) bundling (a.k.a. superposition) which takes two or more input vectors and generates a new vector that is similar to the inputs (performed by bundler 212). The OOD detector 220 uses adaptors 118 that represent layer-wise features as pseudo-orthogonal binary vectors, and then, the at least one reconfigurator 120 uses majority voting to bundle all of the samples from a class into a binary class prototype vector. New samples can be classified into existing classes if its HD vector is close to one of the class prototype vectors based on hamming distance, or it can be classified as OOD if it is far from all of the class prototypes. When OOD data is detected, the reconfigurator 120 initiates the reconfigurator/adaptor generator 214 to produce an additional reconfigurator and adaptor to operate with the encoder 116 to classify the OOD data if and when that data is seen again.

As the model encounters new domains, shallow adaptors 118, which are laterally connected to tap points of the encoder 116, are learned. These adaptors 118 efficiently transform the features tuned for the first domain to be useful for subsequent domains. The adaptors 118 consist of a few convolutional and dense layers that transform unconstrained feature vectors into binary HD feature vectors. The output per-adaptor HD vectors feed into a reconfigurator 120 that is the predictive model for the new domain (a joint OOD detector and classifier). The reconfigurator 120 bundles all of per-adaptor HD vectors into a single aggregated HD vector per input instance. During training, the aggregated HD vectors of all data in the training set from a single class are bundled into a single prototype per class. During inference, classification is performed by comparing the aggregated HD vector of an instance with all of the class prototype vectors stored by the reconfigurator 120. The instance is assigned the class of the nearest prototype, or if it isn't close to any prototype, it is assigned to be OOD for the domain associated with the reconfigurator 120.

In the OOD detector 220, HDC is combined with pre-trained DNNs for novelty detection (i.e., when the OOD detector only sees ID data during training). The OOD detector 220 performs the following: 1) uses adaptors 118 to learn non-linear projections to a pre-determined fixed set of HD vectors; 2) uses fusion from a small subset of layers determined via ZS-NAS instead of every layer; 3) projects to binary HD vectors instead of real-valued HD vectors, saving memory and enabling lighter computation; and 4) enables the model to learn to perform joint OOD detection-classification in an end-to-end manner, resulting in more discriminative representation learning. The HD vectors are aggregated into a single vector, and HD prototype vectors are learned for each class. If the HD vector of a new instance has a distance larger than a fixed threshold to all of the class prototypes, it is flagged as OOD.

To determine if a sample is OOD for a given reconfigurator 120, the aggregate HD vector is computed and compared against the class prototype HD vectors in the reconfigurator. If the minimum hamming distance to any prototype is larger than a fixed threshold T, then the sample is predicted to be OOD:

$$ood ( x ) = {min}_{class} {d}_{hamming} ( {h}_{agg} ( x ) , {h}_{proto}^{class} ) > τ \qquad ( 1 )$$

This works well if the EAR architecture 112 is only interested in determining if a sample is OOD for a single domain. It is often the case that there is a need to determine if a sample is OOD over all domains, or there is a need to identify which set of adaptors/reconfigurators the data should be routed through when knowledge of the true domain is unknown. Such cases may require different thresholds for the reconfigurator 120, and the OOD scores of each reconfigurator 120 may not be one-to-one comparable (e.g., if it is naturally easier to (over) fit a set of adaptors 118 to one domain vs another, noise characteristics may make distances to the nearest prototype not directly comparable). Thus, the EAR architecture 112 uses a calibrated OOD score that is comparable between adaptor sets.

To obtain this calibrated OOD score, the reconfigurator 120 fits a probability distribution over the distances to the nearest prototype for the training set. In one embodiment, the reconfigurator 120 fits a probability distribution (e.g., 3-Parameter Weibull, Gaussian, etc.) to the ID samples:

$${PDF}_{weib} ( x ) = \frac{b}{a} {( \frac{x - c}{a} )}^{b - 1} \begin{matrix}exp ( - {( \frac{x - c}{a} )}^{b} ) , & if x > c \\ 0 , & if x \leq c\end{matrix} \qquad ( 2 )$$

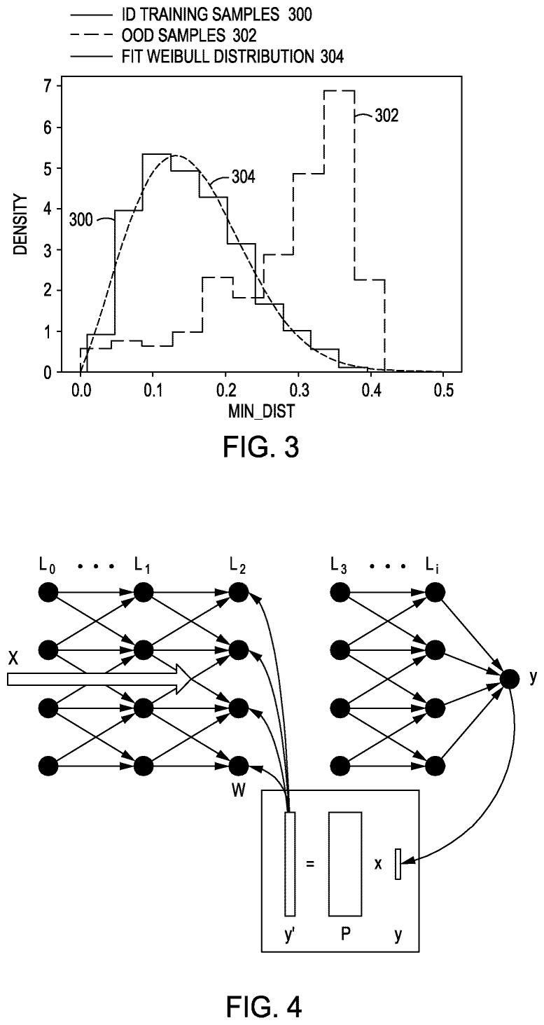

In Eq. 2, a 3-Parameter Weibull distribution is used, where a is the scale parameter, b is the shape parameter, and c is the location parameter. These parameters are fit via maximum-likelihood estimation, and generally, the location parameter becomes zero, simplifying to a 2-Parameter Weibull distribution. FIG. 3 shows a Weibull distribution fit to ID data. Data tends to have a strong right-tail, and thus, a more expressive distribution than the Gaussian is needed.

Once the distribution is fit, the OOD detector 220 scores samples based on how likely the data is to be ID (300 in FIG. 3). The OOD detector 220 uses the CDF of the fit Weibull distribution (304 in FIG. 3) to compute the probability that the distance between a random in-distribution sample and its nearest class prototype is less than the distance between the observed sample and its nearest prototype. The OOD detector 220 selects a hard threshold on the probability to make the final prediction of whether the sample is OOD (302 in FIG. 3) for each reconfigurator 120:

$$ood ( x ) = {CDF}_{weib} ( {min}_{class} {d}_{hamming} ( {h}_{agg} ( x ) , {h}_{proto}^{class} ) ) > τ \qquad ( 3 )$$

If the data is ID, then the encoder 116 and adaptors 118 classify the HD vector and apply a label to identify the feature represented by the HD vector. If the data is OOD, then the reconfigurator 120 uses the reconfigurator/adaptor generator 214 to generate a new reconfigurator 120 and adaptor 118 to enable the encoder/adaptor working with the encoder 116 to classify the currently OOD data as ID when such data is seen again.

In one embodiment, the reconfigurator/adaptor generator 214 uses ZS-NAS 216 to define the structure of the new adaptor and the connection points into the neural network of the encoder 116. In other embodiments, other techniques, such as other forms of neural architecture search (NAS) including, but not limited to, few-shot or full NAS, may be used to define the structure and connections for the adaptors. The ZS-NAS operates as follows: 1) the feature extracting backbone is frozen and the generator 214 only searches for an architecture of shallow adaptor layers, significantly reducing the candidate architecture search space and improving model training speed, and 2) the generator 214 uses ZS-NAS to avoid training the candidate architectures, instead evaluating the candidate model quality via proxy heuristics. The NAS is defined as follows:
Search Space: Definition of adaptors/reconfigurators within reasonable parameter bounds specified by a human.
Search Strategy: Candidate selection via a global optimizer using Bayesian optimization and Gaussian Process Upper Confidence Bounds with sequential domain reduction as the acquisition function.
Performance Estimation Strategy: Zero-shot proxy heuristic via spectral analysis of the nearest neighbor graph of a random batch of input samples.

Proxies for ZS-NAS generally aim to maximize one of the following properties: expressivity, trainability, or generalization. These methods generally require computing or approximating gradients over one or more random batches of data. Computing and storing gradients can be computationally- and memory-expensive. As such, the generator 214 uses a gradient-free proxy heuristic.

Furthermore, existing ZS-NAS methods do not assume the use of a frozen backbone network and may not work as expected when used with the EAR framework. The generator 214 considers the unique properties of the EAR architecture for the resource-constrained use case:
Maximize the expressivity of the representations of each adaptor assuming a fixed pre-trained encoder
Minimize the redundancy of the representations learned across all adaptors.
Minimize the number of trainable parameters

The first objective of the ZS-NAS is to maximize the expressivity of each adaptor. A random batch of data is passed through each randomly initialized, untrained adaptor and features are extracted from the layer preceding the final projection to HD space. The Laplacian of the k-nearest neighbor graph L is computed for this batch of samples in “random” feature space. In one specific embodiment, k equals two. The encoder already extracts useful representations, so the ZS-NAS shouldn't learn adaptors that degenerate features to a singular point or scramble the features into a uniform space. An expressive adaptor will result in a rocky feature landscape characterized by small clusters of data points. This can be achieved by maximizing the number of connected components in the nearest neighbor graph. The Laplacian is decomposed into Eigenvalues λ and Eigenvectors \vec{v}. The number of connected components of the nearest neighbor graph is computed by counting the number of 0-valued Eigenvalues. The constraint that the score is directly proportional to the number of connected components is relaxed, and instead, construct a score that uses the number of loosely connected components (γ controls the strictness of the connected component count; for example, set γ=3):

$${s}_{exp}^{ada} = {\sum }_{i} {max ( 1 - {λ}_{i}^{a d a} , 0 )}^{γ} \qquad ( 4 )$$

The second objective of the ZS-NAS approach is to minimize the redundancy of the representations learned across all adaptors. The ZS-NAS reuses the Eigenvalues and Eigenvectors from the preceding computation and performs spectral clustering for each adaptor. The number of clusters is set based on the number of Eigenvalues smaller than 0.1. The redundancy score measures cluster overlap using the adjusted mutual information metric between all pairs of adaptors.

The final objective is to minimize the number of trainable adaptor/reconfigurator parameters. sₚₐᵣ simply counts the number of trainable parameters across all of the adaptor layers.

The final proxy heuristic for our proposed ZS-NAS score is a weighted sum of the three component scores:

$$s = {\sum }_{all \_ adaptors} ( {s}_{exp}^{ada} + {β}_{0} * {\sum }_{all \_ adaptors} {s}_{par}^{ada} ) + {β}_{1} * {\sum }_{all \_ adaptor \_ pairs} {s}_{red}^{{ada}_{i} , {ada}_{j}} \qquad ( 5 )$$

In one embodiment, β₀ is set to 3×10⁻⁶ and β₁ is set to 5.

Once the adaptor is created, it must be trained. To train the adaptors, the reconfigurator 120 first generates a unique HD vector per class per adaptor (i.e., for ten classes and five adaptors, fifty pseudo-orthogonal vectors are generated) via, for example, the following algorithm (⊗ is the Kronecker product).

```
Require: n > k
Require: n is power-of-two
  k ← number of classes x number of adaptors
  n ← dimensionality of HD vector + 1
  $C ← [ \begin{matrix}1 & 1 \\ 1 & - 1\end{matrix} ]$
  C₀ ← clone(C)
  i = 0
  while / < log₂(n/2) do
    C ← C₀ ⊗ C
    i ← i + 1
  end while
  C ← C[1:n, 1:n]
  Shuffle the rows of C
  C ← C [0:k, 0:n−1]
  C[C = −1] ← 0
```

Other known algorithms may be used for generating the basis vectors. The algorithm above first generates a symmetric orthogonal matrix satisfying {−1,1}^{n×n}. The first row and column of the matrix are removed to improve stability of training the adaptors. While this breaks orthogonality, the matrix remains pseudo-orthogonal. The rows of the matrix are shuffled to help stabilize the training of the adaptors, and HD vectors for each combination of adaptor and class label are selected. Finally, all elements of the HD vectors that are −1 are set to 0.

The reconfigurator 120 selects the dimensionality of the HD vectors to be 2^{[log} ^{₂}^{(#adaptors*#classes+1)]}−1. This ensures that for each adaptor-class pair, there will be a unique mutually (pseudo-) orthogonal HD vector. This vector serves as the target output for any data sample of the specific class that passes through the corresponding adaptor. By forcing orthogonality between the HD vectors across adaptors by construction of the target HD vectors, binding operations are not needed during aggregation.

To map from inputs x to the target HD vectors for an adaptor, the reconfigurator 120 treats the mapping as a high-dimensional binary multi-label classification problem. It uses the weighted binary focal cross-entropy loss averaged over every element i of the predicted HD vector, which forces the adaptors to focus on harder-to-classify samples during training:

$${ℓ}_{foc} = \frac{1}{\# dims} {\sum }_{i = 0}^{\# dims} - {α}_{i} * {( 1 - {p}_{target}^{( i )} )}^{γ} * log ( {p}_{target}^{( i )} ) \qquad ( 6 )$$

p_{target}⁽ⁱ⁾ is the probability that the element i output by the adaptor is assigned (i) to its correct target value, a is a weight term that corrects for imbalance (computed from the training data) within the binary element-wise “labels”, and γ is a constant controlling how much focus is put on harder-to-classify samples (for example, gamma=2).

Beyond enabling easy feature-fusion between adaptors, there are other practical reasons for projecting to target binary class HD vectors at each adaptor. Every class for every adaptor is assigned a unique HD vector. The goal is to map all input instances to the HD vector corresponding to their class label for the given adaptor. To learn this mapping, if each HD vector has a dimensionality of D, then a binary classifier is learned for each of the D dimensions. Because each element is assigned either 0 or 1 randomly and all instances from the same class share a target class vector, this effectively means that the model is learning to predict a random partitioning of the classes into two meta-labels for each element of the HD vector. Because the target HD vectors are mutually orthogonal per class, these D classifiers have low-redundancy. The mapping to an HD vector can be thought of as an ensembling method whereby each adaptor forms a strong multi-class classifier by ensembling many low-redundancy weak binary classifiers. Furthermore, bundling between adaptors is another mathematically principled form of ensembling. Combining all of these characteristics, the mapping from inputs to a final HD vector embedding ultimately leads to highly discriminative models with high noise tolerance.

In an alternative embodiment, a back-propagation (BP) free training technique may be used to train the new adaptors as well as initially training the encoder before it is frozen. Although the technique, referred to herein as the target projection Stochastic Gradient Descent (tpSGD) technique, is, in one exemplary embodiment, used by the tpSGD module 218 of the reconfigurator/adaptor generator 214 for training the adaptors and/or training the encoder 116, the tpSGD technique has broader application and includes the following features:
Local efficient computation per trainable layer using stochastic gradient descent and target propagation. tpSGD uses distinctively distributed random projections of the labels to train each layer in a neural network.
Extend target projection to multi-channel convolutional layers via filter-based sampling to extend to deeper networks and convolutional layers.
Demonstrates state-of-the-art (SoA) performance comparing to other backpropagation free algorithms. Useful in training Deep Neural Networks (DNN) and. In one exemplary embodiment, training VGG consisting of 11 trainable layers.

tpSGD is designed for BP free training to larger datasets and deeper networks required for complex tasks. tpSGD utilizes gradient descent-based optimization for the individual layers instead of the Moore-Penrose (MP) pseudo-inverse which optimizes weights on an entire data set at once. tpSGD can process a CIFAR dataset in batches providing more freedom to extend to datasets and tasks with larger memory requirements.

FIG. 4 illustrates the tpSGD training process in accordance with at least one embodiment of the invention. tpSGD is a feedforward only optimization algorithm. In tpSGD, each layer Lᵢ in the network is trained sequentially starting from the layers closest to the input. For a given layer Lᵢ in an adaptor neural network with i∈N layers, the input to that layer xᵢ is obtained by running the forward pass over all previous j=1 to i−1 layers. The target output yᵢ is obtained via a random projection of the one-hot encoding of the data labels. The input xᵢ and projected targets yᵢ are used to train the layer and determine weights W using Adam optimizer and the Mean Squared Error (MSE) between the predictions and yᵢ (either before or after activation).

Once the layer Lᵢ has been trained, the tpSGD module 218 of the reconfigurator/adaptor generator 214 fixes the weights W and moves on to the next layer Lᵢ₊₁ following the same approach. This particular strategy was selected to allow generator 214 to discard the projection matrices after each layer is trained, providing a particularly economical algorithm. In other embodiments, the projections are retained, or re-sampled to create robust representations. Once the final layer is reached, the generator 214 no longer requires a projection, and so the weights are obtained using the one-shot encodings as targets, again with MSE.

The tpSGD algorithm may be represented as follows:

```
For i in [0,1, ...,N]
  For x, y in entire training data:
    x’ ← x
    For j in [0,1, ...,i− 1]
      x’ ← Lⱼ(x’)
    y’ ← Pⱼ(y) random Pⱼ
    Wᵢ ← SGD(x’, y’, Wᵢ)
```

In target propagation, the labels are “propagated” by sequentially inverting each operation (layers and activations) and applying that to obtain the corresponding input that generated the labels. For instance, for a linear layer, this involves obtaining an approximate value for the inverse of the layer weights via a Moore-Penrose pseudo-inverse. Inverting the activations is discussed in more detail below. While target propagation provides a strong signal for learning, it is computationally expensive to obtain the inverses, in particular for Conv2D layers.

In target projection, one-hot encodings of the labels are projected to a given layer during the optimization step. Given an intermediate layer Lᵢ, in a neural network, local targets yᵢ are generated for the layer by projecting the data labels y− via a random projection matrix (Pᵢ).

In tpSGD, the focus is to provide a fast and scalable algorithm that supports target projection and propagation (or a combination of both). By using selected target projection, tpSGD replaces the need to invert all of the layers and activations after a given layer, with a single matrix multiplication. The following disclosure focuses on the details of generating the random projection matrices.

In the simplest case of a fully connected layer with n-nodes and a classification problem with bs batch size, nc classes, the tpSGD technique maps a batch of labels with dimensions (bs,nc) to one with dimensions (bs,n) by multiplying by a random matrix P with dimensions (nc,n).

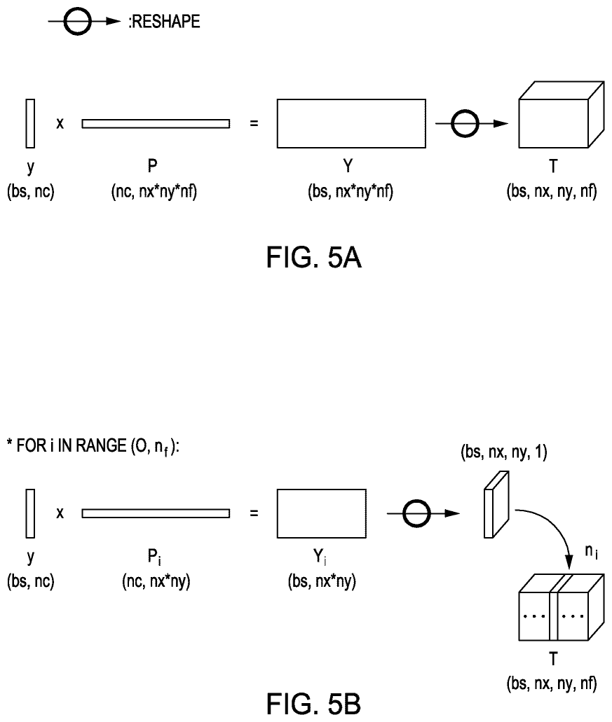

FIGS. 5A and 5B illustrate two procedures for constructing target features T for convolutional layers (i.e., in a Convolutional Neural Networks (CNN)) using random matrices P in accordance with at least one embodiment of the invention. The procedures generate the target features for intermediate Conv2D layers of the CNN. FIG. 5A shows the basic or “naive” approach vs. filter-based sampling. In FIG. 5B, the tuples in parenthesis under the labels illustrate the tensor sizes.

Assume the output of a given Conv2D layer has dimensions (bs,nx,ny,nf), where bs is the size of the mini-batch being processed, nx and ny are the x and y dimensions of the filtered image, and nf are the number of filters. In FIG. 5A, the naive approach, the procedure generates a single, long projection matrix P with dimensions (nc,nx×ny×nf) and reshapes the output to match the target dimensions.

In FIG. 5B, the procedure generates nf different projection matrices Pᵢ of size (bs,nx×ny) for each of the i∈{1, 2, . . . ,nf} filters, sampling from a different random distribution for each. The procedure samples from normal distributions with varying standard deviations in the range [0,1) at equally spaced intervals.

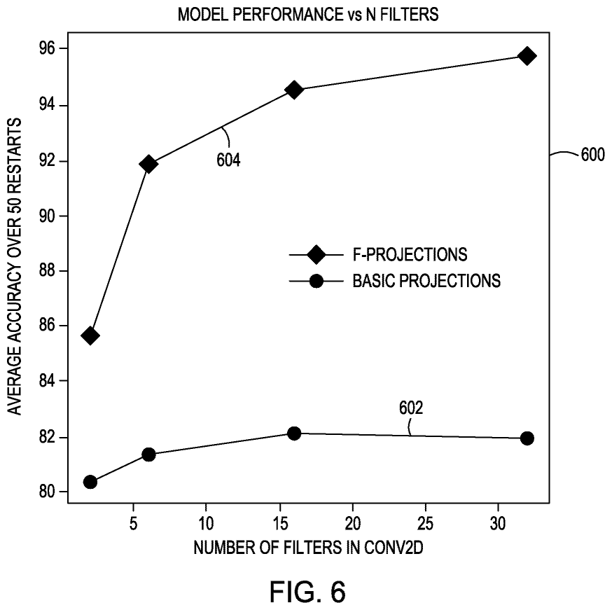

FIG. 6 depicts a graph 600 the difference in performance between these two sampling methods, where the basic approach performance is shown as curve 602 and the filtered approach performance is shown as curve 604. A model, consisting of a Conv2D layer, leaky ReLU activation and a final linear classification layer was trained using our tpSGD algorithm on MNIST using both the basic sampling and filter-based method. Whereas the basic sampling shows little to now improvements as the number of filters in the layer increased, filter-based sampling projections show steady improvement, albeit with diminishing returns. On the other hand, FIG. 5B shows that the training time incurs a constant penalty.

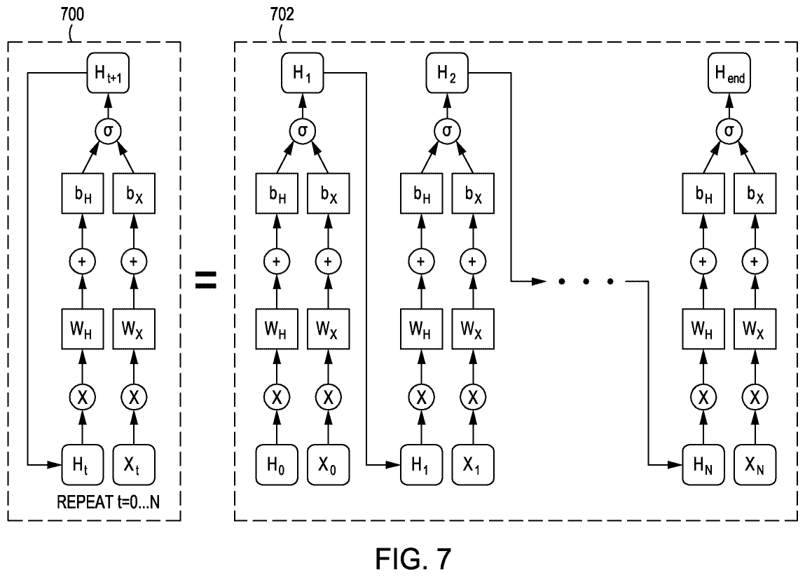

tpSGD may be used for training recurrent neural networks (RNNs) using random target projection to promote learning in recurrent networks. FIG. 7 depicts a representation of a simple recurrent cell 700 and its “unrolled” equivalent 702 that is used to formulate tpSGD update rules for RNNs. The recurrent cell computes the following:

$${H}_{i + 1} = sigmoid ( {H}_{t} {W}_{H} + {b}_{H} + {X}_{t} {W}_{X} + {b}_{X} \qquad ( 7 )$$

where Hᵢ is the hidden state input at time t, Xₜ are the input features at time t, W_{H}, b_{H}, W_{X}, and b_{X} are the learnable parameters of the cell (shared over all time steps), and Hₜ₊₁ is the hidden state that serves as input to the next time step.

In order to apply target propagation to this recurrent cell, the procedure begins by unrolling the recurrent cell 700 over time for a fixed problem-specific sequence length. Unrolling the cell produces a feed-forward-like network 702 where every layer shares a common set of learnable parameters but uses the hidden state output by the previous layer with time step-dependent input features, each corresponding to a token from the original sequence. See FIG. 7 for a visual depiction of this process.

Comparing the feed-forward multi-layered perceptron to the unrolled recurrent layer, there are two key differences: 1) there are two linear functions that feed into the non-linearity per unrolled “layer”, and 2) the weights are shared between these unrolled “layers”. (1) is trivial to handle by updating the parameters of each function separately. To formulate an update equation, the procedure makes use of the fact that weights of the recurrent cell can be frozen for the current training iteration and updated over all time steps simultaneously, i.e., with frozen weights, the procedure models a forward pass through the unrolled recurrent cell as:

$$[ \begin{matrix}{H}_{1} \\ {H}_{2} \\ … \\ {H}_{end}\end{matrix} ] = σ ( [ \begin{matrix}{H}_{0} {X}_{0} \\ {H}_{1} {X}_{1} \\ … \\ {H}_{N} {X}_{N}\end{matrix} ] [ \begin{matrix}{W}_{H} \\ {W}_{X}\end{matrix} ] ⊕ ( {b}_{H} + {b}_{X} ) ) \qquad ( 8 )$$

where ⊗ represents row-wise addition of a vector to a matrix. Since these weights are frozen and updated simultaneously for all time steps and tpSGD doesn't enforce any backward propagation requirements, the H_{S} can be treated as independent inputs. Then the above formulation of the recurrent layer is equivalent to a feedforward linear layer plus nonlinear activation.

When computing the gradient of W_{H}, there is no dependency on X and when computing the gradients of W_{X}, there is no dependency on H, so if the two sets of weights for the recurrent cell are updated simultaneously with the assumption that when W_{H} is updated W_{X} is frozen and vice versa, each set of parameters can be updated separately. Also, since we assume weights are frozen for the current time steps and weights are updated simultaneously for this recurrent cell, when gradients are computed using this formulation, it is equivalent to computing gradients over each (Hₜ, Xₜ) separately and summing over all time steps (i.e., similar to gradient accumulation over different batches of data). This means the procedure computes the individual pseudo-gradients per time step and sums or averages them over all time steps, storing only the accumulated gradients. Thus, to train the parameters of a recurrent cell for a given timestep, the procedure uses the following pseudo-gradient updates, where it assumes a differ projection of the optimal one-hot encoded labels using different projection matrices for each time step:

$${[ \begin{matrix}{W}_{H} \\ {b}_{H}\end{matrix} ]}^{( k + 1 )} = {[ \begin{matrix}{W}_{H} \\ {b}_{H}\end{matrix} ]}^{( k )} + {η [ \begin{matrix}∇ {W}_{H} \\ ∇ {b}_{H}\end{matrix} ]}^{( k )} \qquad ( 9 )$$

$${[ \begin{matrix}{W}_{X} \\ {b}_{X}\end{matrix} ]}^{( k + 1 )} = {[ \begin{matrix}{W}_{X} \\ {b}_{X}\end{matrix} ]}^{( k )} + {η [ \begin{matrix}∇ {W}_{X} \\ ∇ {b}_{X}\end{matrix} ]}^{( k )} \qquad ( 10 )$$

$$[ \begin{matrix}∇ {W}_{H} \\ ∇ {b}_{H}\end{matrix} ] = {\sum }_{t = 0}^{N} [ \begin{matrix}{H}_{t}^{T} \\ {1}^{T}\end{matrix} ] {D}_{H} , {[ \begin{matrix}∇ {W}_{X} \\ ∇ {b}_{X}\end{matrix} ]}^{( k )} = {\sum }_{t = 0}^{N} [ \begin{matrix}{X}_{t}^{T} \\ {1}^{T}\end{matrix} ] {D}_{H} \qquad ( 11 )$$

$${D}_{H} = sign ( Y * {B}_{t} - {H}_{t + 1} ) ⊙ {H}_{t + 1} ⊙ ( 1 - {H}_{t + 1} ) \qquad ( 12 )$$

where ⊙ is element-wise multiplication and “1” represents the generalized scalar/vector/matrix of all ones.

The initial weights of the recurrent cells can be all zeros or drawn uniformly randomly with small magnitude. To initialize the projection matrices for tpSGD, the procedure uses random matrices with orthogonal rows.

The weights can be updated either every time a forward pass occurs through the recurrent layer, or in the tpSGD framework using multiple forward passes through the recurrent layer before sending the final feature vector to the next layer of the complete model, which can be any layer compatible with tpSGD (Linear, Conv2D, or a different Recurrent layer).

Target projection can be used to generate values that can be inserted into the graph either before or after the activation is applied. To support these options in the framework. The procedure includes the functionality to deactivate the projected targets by applying the inverse of the activation functions when available, or a suitable approximation of such when it isn't.

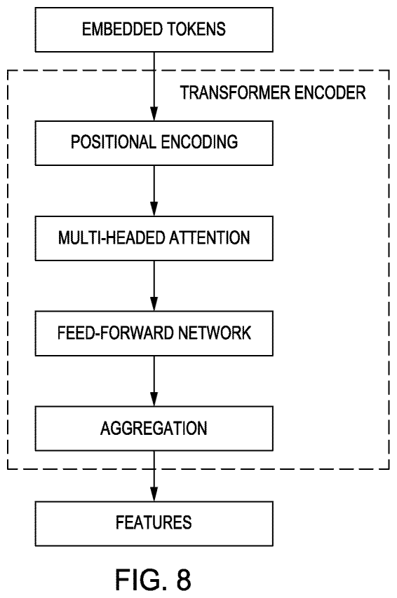

tpSGD employs two important optimizations to extend the approach and enable edge training of attention-based neural networks. FIG. 8 illustrates a standard definition of a transformer encoder layer, the procedure first “linearizes” the multi-headed self-attention layer, allowing the procedure to compress the sequence length and reduce both the memory footprint and inference time. Then, the procedure trains the entire transformer encoder layer as a whole, constructing the projection matrices as is done for linear layers to generate the target features during training with tpSGD.

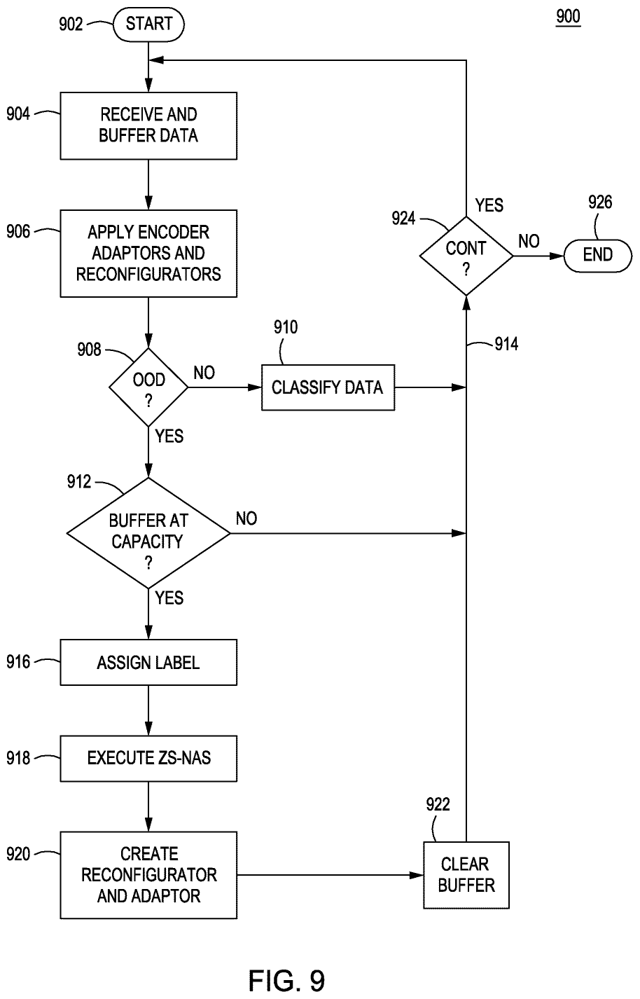

FIG. 9 depicts a flow diagram of a method 900 of the EAR architecture operation in accordance with at least one embodiment of the invention. For clarity, it is assumed that the EAR architecture only sees data streaming from a single domain/task at a given time, but the domain/task can shift at any time. Thus, the model needs to operate over sequences of tasks where task boundaries are not known.

Although the following description uses reconfigurators and adaptors in the plural, it should be understood that the EAR architecture may comprise at least one adaptor and at least one reconfigurator.

The method 900 begins at 902 and proceeds to 904 where the EAR architecture receives and buffers data. As data arrives, at 906, the data is applied to the encoder once and then passed through each set of adaptors/reconfigurators. The reconfigurators process the data as described above to determine if the data is ID or OOD. The query at 908 represents this OOD processing.

If the data is ID according to any reconfigurator, then, at 910, the data is classified according to the reconfigurator of closest match (smallest OOD score). The method 914 proceeds along path 914 to query 924 to determine if the method 900 should continue and process additional data. If the query 924 is affirmatively answered, the method 900 continues to 904 to process additional data. If the query 924 is negatively answered, the method 400 ends at 926.

When a new task is encountered, new data will appear to be OOD to all reconfigurators and the query at 908 is affirmatively answered. Once the model is sufficiently confident that there has been a domain shift, it may verify with an oracle (e.g., human-in-the-loop) that a shift has occurred. Alternatively, the domain shift may be confirmed by an automated process.

At 912, the method 900 queries whether the buffer is at capacity. If the query is negatively answered, the method 900 proceeds to 904 to continue collecting data for the new domain until the buffer is at capacity. If the query is affirmatively answered, the method 900 proceeds to 916. At 916, the OOD data is assigned a new classification label. This can be performed by an oracle or through an automated process.

At 918, the method 900 executes the ZS-NAS process as described above to identify the structure and placements of a new set of adaptors and reconfigurator. At 920, the new adaptor/reconfigurator is created and trained on the collected OOD data. To determine when a new domain/task appears, the model monitors whether the proportion of the last N data samples assigned as OOD is greater than a specified threshold; after which, the update process is triggered.

At 922, the method 900 clears the buffer and proceeds to the continuation query 424 to either continue processing data or end.

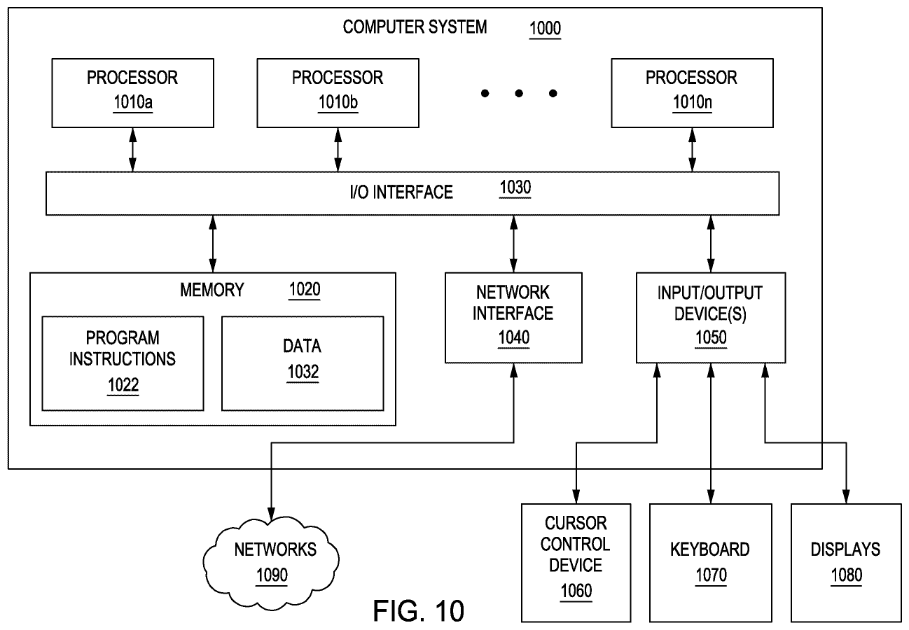

FIG. 10 depicts a computer system 1000 that can be utilized in various embodiments of the present invention to implement the computing device 100-N, according to one or more embodiments.

Various embodiments of an adaptable, continually learning, hyperdimensional EAR architecture, as described herein, may be executed on one or more computer systems, which may interact with various other devices. One such computer system is computer system 1000 illustrated by FIG. 10, which may in various embodiments implement any of the elements or functionality illustrated in FIGS. 1 through 9. In various embodiments, computer system 1000 may be configured to implement methods and functions described above. The computer system 1000 may be used to implement any other system, device, element, functionality or method of the above-described embodiments. In the illustrated embodiments, computer system 1000 may be configured to implement the edge device 100-N and implement the adaptable, continually learning hyperdimensional EAR architecture functions as processor-executable executable program instructions 1022 (e.g., program instructions executable by processor(s) 1010) in various embodiments.

In the illustrated embodiment, computer system 1000 includes one or more processors 1010a-1010n coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In various embodiments, any of the components may be utilized by the system to receive user input described above. In various embodiments, a user interface may be generated and displayed on display 1080. In some cases, it is contemplated that embodiments may be implemented using a single instance of computer system 1000, while in other embodiments multiple such systems, or multiple nodes making up computer system 1000, may be configured to host different portions or instances of various embodiments. For example, in one embodiment some elements may be implemented via one or more nodes of computer system 1000 that are distinct from those nodes implementing other elements. In another example, multiple nodes may implement computer system 1000 in a distributed manner.

In different embodiments, computer system 1000 may be any of various types of devices, including, but not limited to, a personal computer system, desktop computer, laptop, notebook, tablet or netbook computer, mainframe computer system, handheld computer, workstation, network computer, IoT sensor device, a camera, a set top box, a mobile device, a consumer device, application server, storage device, a peripheral device such as a switch, modem, router, or in general any type of computing or electronic device.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments processors 1010 may be general-purpose or embedded processors implementing any of a variety of instruction set architectures (ISAs). In multiprocessor systems, each of processors 1010 may commonly, but not necessarily, implement the same ISA.

System memory 1020 may be configured to store program instructions 1022 and/or data 1032 accessible by processor 1010. In various embodiments, system memory 1020 may be implemented using any non-transitory computer readable media including any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 1020. In other embodiments, program instructions and/or data may be received, sent or stored upon different types of computer-accessible media or on similar media separate from system memory 1020 or computer system 1000.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network (e.g., network 1090), such as one or more external systems or between nodes of computer system 1000. In various embodiments, network 1090 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1040 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or accessing data by one or more computer systems 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

In some embodiments, the illustrated computer system may implement any of the operations and methods described above, such as the functions illustrated by the diagram of FIG. 9. The functional blocks of FIG. 9 may be implemented in the user device or may be implemented partially in the user device and partially in a server. In other embodiments, different elements and data may be included.

Those skilled in the art will appreciate that computer system 1000 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. An apparatus configured to process data using machine learning comprising:
an encoder configured to encode input data to detect features in the input data;
at least one reconfigurator, coupled to the encoder and comprising an at least one out-of-distribution detector configured to detect when the input data is out-of-distribution, configured to create at least one adaptor when the input data is out-of-distribution; and
the at least one adaptor, coupled to the encoder and the at least one reconfigurator, configured to operate with the encoder and at least one reconfigurator to encode the out-of-distribution input data into an HD vector and classify the HD vector.

2. The apparatus of claim 1, wherein at least one of encoder, at least one reconfigurator and at least one adaptor comprises a neural network.

3. The apparatus of claim 1, wherein the input data comprises at least one of video, audio, temperature, radiation, seismic, motion, radio frequency (RF) signals, text, and biometric sensor data.

4. The apparatus of claim 1, wherein the at least one adaptor and/or encoder are trained using target projection stochastic gradient descent.

5. The apparatus of claim 1, wherein the at least one adaptor is created using a neural architecture search.

6. The apparatus of claim 4, wherein the neural architecture search defines an architecture for the at least one adaptor.

7. The apparatus of claim 2, wherein the encoder neural network is trained and frozen.

8. A method for processing information comprising:
receiving input data;
detecting whether the input data is out-of-distribution; and
if the input data is out-of-distribution, creating at least one adaptor to operate with an encoder and at least one reconfigurator to classify the out-of-distribution input data.

9. The method of claim 8, wherein the input data comprises at least one of video, audio, temperature, radiation, seismic, motion, radio frequency (RF) signals, text, and biometric sensor data.

10. The method of claim 8, further comprising training the at least one adaptor and/or encoder using target projection stochastic gradient descent.

11. The method of claim 8, further comprising creating the at least one adaptor using a neural architecture search.

12. The method of claim 10, wherein the neural architecture search defines an architecture for the at least one adaptor.

13. The apparatus of claim 8 wherein at least one of the encoder, at least one reconfigurator and at least one adaptor comprise a neural network.

14. The method of claim 13, wherein the encoder neural network is trained and frozen.

15. An apparatus comprising at least one processor and at least one non-transient computer readable media, where the at least one non-transient computer readable media stores instructions that, when executed by the at least one processor, causes the apparatus to perform operations comprising:
receiving input data;
detecting whether the input data is out-of-distribution; and
if the input data is out-of-distribution, creating at least one adaptor to operate with an encoder and at least one reconfigurator to classify the out-of-distribution input data.

16. The apparatus of claim 15, wherein the input data comprises at least one of video, audio, temperature, radiation, seismic, motion, radio frequency (RF) signals, text, and biometric sensor data.

17. The apparatus of claim 15, further comprising training the at least one adaptor and/or encoder using target projection stochastic gradient descent.

18. The apparatus of claim 15, further comprising creating the at least one adaptor using a neural architecture search.

19. The apparatus of claim 18, wherein the neural architecture search defines an architecture for the at least one adaptor.

20. The apparatus of claim 15, wherein the encoder comprises a neural network that is trained and frozen.
